(19) United States
(12) Patent Application Publication
(10) Pub. No.: US 2025/0317998 A1
(43) Pub. Date: Oct. 9, 2025

(54) METHOD AND A RELAY UE (USER EQUIPMENT) FOR SERVICE RELAYING

(71) Applicant: Continental Automotive Technologies GmbH, Hannover (DE)

(72) Inventors: Andreas Andrae, Frankfurt am Main (DE); Hueseyin Daglioglu, Frankfurt am Main (DE); Osvaldo Gonsa, Frankfurt (DE); David Gonzalez Gonzalez, Egelsbach (DE)

(73) Assignee: Continental Automotive Technologies GmbH, Hannover (DE)

(21) Appl. No.: 18/865,140

(22) PCT Filed: May 10, 2023
(86) PCT No.: PCT/EP2023/062519

§ 371 Date: Nov. 12, 2024

Related U.S. Application Data
(63) Continuation-in-part of application No. PCT/EP2022/062658, filed on May 10, 2022.

(30) Foreign Application Priority Data
May 10, 2022 (WO) PCT/EP2022/062658

(51) Int. Cl. H04W 76/14; H04W 88/04

(52) U.S. Cl. CPC H04W 76/14; H04W 88/04

(57) ABSTRACT

A method for Service Relaying in a Relay User Equipment (UE) and such Relay UE is provided. The method includes the following steps. A connection between a Relay UE and a UE is established. A Service Catalogue of a Remote Service Provider is received. The Remote Service Provider is arranged for providing services to a UE. The Service Catalogue includes information about these services. Meta-data is generated which includes additional information about the services for the UE. Information about the Service Catalogue and about the meta-data is provided to the UE. The UE selects one of the services based on the provided information and the Relay UE relays the selected service from the Remote Service Provider to the UE.

### CROSS-REFERENCE TO RELATED APPLICATIONS

The present application is a National Stage Application under 35 U.S.C. § 371 of International Patent Application No. PCT/EP2023/062519 filed on May 10, 2023, and claims priority from German Patent Application No. PCT/EP2022/062658 filed on May 10, 2022, in the German Patent and Trademark Office, the disclosures of which are herein incorporated by reference in their entireties.

### TECHNICAL FIELD

The present disclosure relates to a method and a Relay UE (User Equipment) for service relaying.

### BACKGROUND

Today's vehicles are limited in terms of computing capabilities and face stringent cost restrictions. However, advanced and more sophisticated use cases exhibit challenging computing requirements, e.g., due to their dependency on artificial intelligence/machine learning (AI/ML), which drives the need for access to services in a powerful cloud infrastructure.

Furthermore, vehicles that use cellular connectivity for accessing server-based and/or AI-powered services may face situations of poor or insufficient mobile network coverage, particularly when using high frequencies (i.e., millimeter waves). As situations of limited, partial, or no mobile network coverage are not unlikely, vehicles operating under these circumstances may not be able to access those cloud-based services.

### SUMMARY

The objective of the present disclosure is to improve access to remote services in areas with limited or no network coverage.

The objective of the present disclosure is met by providing methods according to claims 1 and 8, a Relay UE according to claim 9 and a UE according to claim 10.

According to a first aspect a method for Service Relaying in a Relay UE is provided, including the steps of:
receiving a Service Catalogue (SC) of a Remote Service Provider,
establishing a connection between the Relay UE and a UE, wherein the Remote Service Provider is arranged for providing services to a UE;
wherein the Service Catalogue comprises information about the services; wherein the Relay UE is arranged for relaying one or more of the services from the Remote Service Provider to the UE;
generating meta-data, wherein the meta-data comprises additional information about the services for the UE;
providing information about the Service Catalogue and about the meta-data to the UE; and, when the UE selects one of the services based on the provided information, relaying the selected service from the Remote Service Provider to the UE.

A Relay UE is a User Equipment that is arranged for relaying a service. A User Equipment may be a vehicle that is arranged for connecting to a communication network, a mobile telephone or any other device that is arranged for connecting to a communication network, such as a wireless network. Examples of such a communication network are cellular mobile networks, networks as defined by 3GPP, a WLAN, a Bluetooth network and DSRC networks.

In case a UE cannot connect to a first communication network such that it cannot receive desired cloud-based services, but it can connect to a Relay UE using a second communication network, the Relay UE may, when it is also connected to the first communication network, relay the cloud-based services from the first communication network over the second communication network to the UE. The first communication network may be cellular mobile network and the second communication network may be a WLAN-based network.

In that case, the Relay UE can help to extend the mobile network's coverage and act as a “middleman” for accessing and enabling connected, cloud-based services.

In one or more embodiments, the services comprise services at a connection layer and/or services at an application layer, wherein the services at an application-layer may comprise at least one of a group comprising:
remote computing, such as for Artificial Intelligence calculations or Machine Learning calculations;
remote storage of data;
infotainment;
entertainment and gaming;
data exchange with remote entities.

A Remote Service Provider may be one or more (clustered) servers that are arranged for generating—in communication with the UE-one or more of the services as described in this document. These servers may be provided in the cloud.

Alternatively, a UE or even a Relay UE may be provided with a server (functionality) that serves as a Remote Service Provider, such as in the same vehicle as the UE or Relay UE, more particularly in the High-Performance Computer of the vehicle.

A Remote Service Provider may be connected to other computing devices, such that the Remote Service Provider is arranged for providing computing or storage services on these computing devices. Such computing devices may be so-called intelligent roadside units, which may be in the neighborhood of the UE needing the computing or storage service.

The Remote Service Provider may also provide a Service Catalogue, which comprises information about these services. In case these services are services at a connection layer, the information may be information regarding the needed bandwidth of the connections and regarding the needed QoS of the connections in terms of throughput, delay, and latency.

In case these services are services at an application layer the information may be information regarding the needed bandwidth and QoS of the connection but also information about the kind of the application, for example “remote computing for machine learning calculation.”

According to the present disclosure, the Service Catalogue is received, for example, by the Relay UE. The Service Catalogue may be pushed (for example, by the Remote Service Provider broadcasting the Service Catalogue) or may be retrieved (for example, by the Relay UE requesting the Service Catalogue, such as periodically).

In one or more embodiments, a Relay Service Code (RSC) as defined by 3GPP may be used to indicate the services that the Relay UE may provide to the UE. In one or more embodiments, the Relay Service Code comprises information relating to the Service Catalogue. In one or more embodiments, the Relay Service Code may also be used to indicate whether the Relay UE is a Layer-3 or Layer-2 Relay. In one or more embodiments, discovery messages including the Relay Service Code may be exchanged between the Relay UE and the UE.

In general, it is noted that the so-called OSI-model defines layers in a communication stack. Layer 3 and Layer 2 connections are defined accordingly. Connectivity services may then be defined as services using at least one of layers 1-3. Application services may be defined as services using at least layer 7.

In one or more embodiments, the Service Catalogue, provided by the Remote Service Provider, may be stored in a cloud system, a V2X server, the Remote Service Provider itself, or another UE.

According to the present disclosure, the meta-data is generated and provided to the UE. The meta-data comprises additional information about the services for the UE. From the meta-data it may be derived how the respective service will be experienced by the user of the UE. The available radio resources and QoS may have its influence on how the respective service will be experienced, but when the radio resources and QoS are sufficiently available, other factors may have a large influence on how the respective service will be experienced, for example, the status and processing capabilities of the Relay UE and/or Remote Service Provider. Information relating to these factors may be included in the meta-data.

This additional information may facilitate the selection of services by the UE. For example, the UE may be connected to two different Relay UEs, which both provide a Service Catalogue including the same service provided by the same Remote Service Provider. The meta-data regarding these two services may be used to select one of these two services.

In one or more embodiments, the meta-data includes addition information regarding at least one of a group including:
Quality of Service of a respective service;
estimated processing load of the Relay UE;
estimated use of network resources (e.g., bandwidth);
estimated energy consumption;
battery status of the Relay UE;
costs of a respective service; and,
rating of the Remote Service Provider.

In one or more embodiments, separate discovery messages including the meta-data may be exchanged between the Relay UE and the UE.

In one or more embodiments, the Relay UE and the Remote Service Provider are provided in a single device. If the functionalities of the Relay UE and the Remote Service Provider are provided as software programs, it may be the case that both software programs are stored on and executed by a single device, for example a High-Performance Computer of a vehicle. If the Relay UE and the Remote Service Provider are each embodied in a separate computing unit, the two computing devices may be provided together in a single device, for example a vehicle.

In one or more embodiments, the method further includes the steps of:
receiving another Service Catalogue from another Remote Service Provider, wherein the other Remote Service Provider is arranged for providing other services to the UE; wherein the other Service Catalogue includes information about the other services; wherein the Relay UE is arranged for relaying one or more of the other services from the other Remote Service Provider to the UE;
generating other meta-data, wherein the other meta-data includes additional information about the other services for the UE;
providing information about the other Service Catalogue and about the other meta-data to the UE.

It may be the case that the Relay UE is able to relay services from two different Remote Services Providers. In order to facilitate a selection of services by the UE, the Relay UE may provide Service Information about services from both Remote Service Providers.

In one or more embodiments, the method further includes the steps of:
creating one or more further services based on a selection and/or combination of services provided by the Remote Service Provider and/or the other services provided by the other Remote Service Provider;
generating a further Service Catalogue that includes information about the further services;
generating further meta-data, wherein the further meta-data includes additional information about the further services for the UE;
providing information about the further Service Catalogue and about the further meta-data to the UE.

An advantage of this embodiment may be that the Relay UE can select and/or combine the services provided by one or more Remote Service Providers and thus can offer selected or new/further services to the UE. For example, the computing capabilities of vehicles (e.g., public busses, garbage trucks, community taxies) equipped with computing, storage, and direct wireless communications technologies can enable new services (e.g., Infotainment-, safety-, or IoT-related) for any type of vehicle or UE, which does not possess high performance computing capabilities, but supports any V2X or D2D communication technology (e.g., C-V2X, WiFi).

In one or more further embodiments, the selection and/or combination is based on the respective meta-data.

In one or more embodiments, the information provided to UE about the respective Service Catalogues (i.e., the Service Catalogue, the other Service Catalogue and/or the further Service Catalogue) and about the respective meta-data does not include all the information available in the Relay UE about the respective Service Catalogues and about the respective meta-data. That means that the Relay UE is arranged for making a selection from all the received and/or generated information about the Service Catalogues and the respective meta-data and for providing only the selection information to the UE. In one or more further embodiments, the selection is based on the respective meta-data.

An advantage of this may be the reduced requirements for processing power in the UE, since part of the selection of services is executed in the Relay UE.

In one or more embodiments, the method further includes the step of generating the information about services, other services and/or further services, in which the information is logically structured and/or provided with a hierarchy. An advantage of this embodiments may be that it facilitates automated selection of the services by the UE or by the Relay UE.

According to another aspect of the present disclosure, a method for selecting a relayed service in UE is provided, including the steps of:
establishing a connection between the UE and a Relay UE;
receiving information about a Service Catalogue of a Remote Service Provider and about meta-data from a Relay UE, wherein the Service Catalogue includes information about services provided by the Remote Service Provider and wherein the meta-data is generated by the Relay UE and includes additional information about the services;
selecting one of the services based on the provided information; and,
receiving the selected service from the Remote Service Provider relayed by the Relay UE.

According to another aspect of the present disclosure a Relay UE for Service Relaying is provided, including a
a first communication unit for communicating with a Remote Service Provider and a second communication unit for communicating with a UE;
a processing unit connected to the first and second communication unit and arranged for carry out the steps of the method of any of the claims 1-7 or any further embodiments of the method as described in this document.

The first communication unit may be arranged for communicating using a first network and the second communication unit may be arranged for communicating using a second network. In one or more embodiments, the first and second network are different networks, optionally using different network technologies. In one or more embodiments, the first and second communication unit are provided combined in a single communication device.

According to yet another aspect of the present disclosure, a UE for receiving a relayed service is provided, including:
a communication unit for communicating with a Relay UE;
a processing unit connected to the communication unit and arranged for carry out the steps of the method of claim 8 or any further embodiments of the method as described in this document.

According to another aspect of the present disclosure, a computer program is provided, including instructions which, when the program is executed by a computer, cause the computer to carry out the steps of the method of any of claims 1-7 and/or claim 8. Also, a computer-readable medium having stored thereon the computer program of claim 11 is provided.

The working, advantages, and embodiments of the Relay UE, the UE as well as the working, advantages, and embodiments of the computer program and computer-readable medium, correspond with the working, advantages, and embodiments of the methods as described in this document, mutatis mutandis.

### BRIEF DESCRIPTION OF THE DRAWINGS

For a more complete understanding of the present disclosure, reference in the following description is made to the accompanying drawings in which:

FIG. 1 shows a schematic overview of a User Equipment (UE), more specifically a Relay UE, according to one or more embodiments of the present disclosure;

FIG. 2 shows a schematic overview of a method for Service Relaying in a Relay UE of FIG. 1, according to one or more embodiments of the present disclosure;

FIG. 3 shows a schematic overview a use case of the present disclosure according to one or more embodiment of the present disclosure;

FIG. 4 shows a schematic overview of another use case of the present disclosure according to one or more embodiment of the present disclosure;

FIG. 5 shows a schematic overview of a method for selecting a relayed service in UE according to one or more embodiment of the present disclosure; and,

FIG. 6 shows a schematic overview of yet another use case of the present disclosure according to one or more embodiment of the present disclosure.

### DETAILED DESCRIPTION

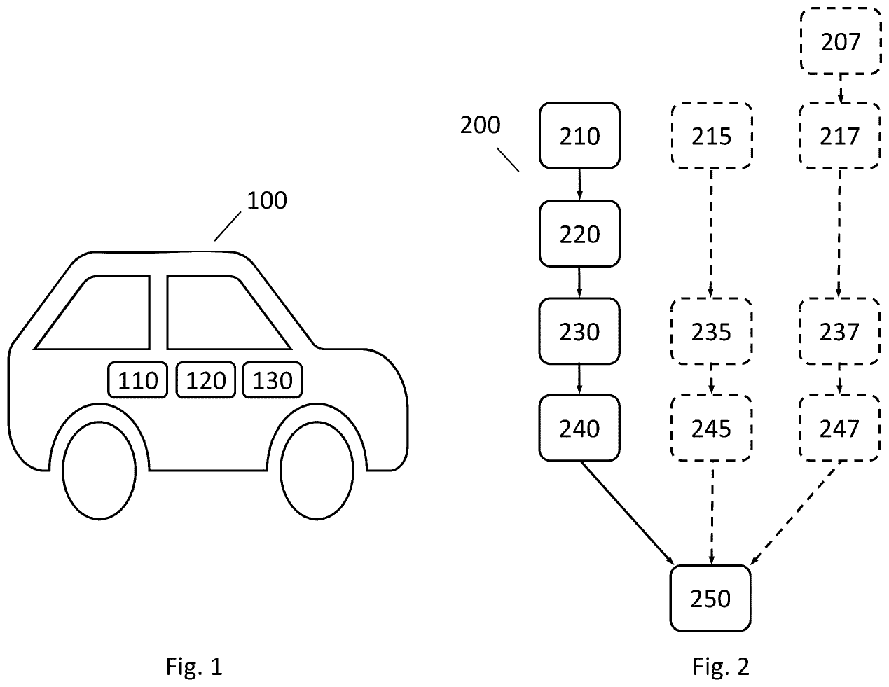

FIG. 1 shows a schematic overview of an example of a User Equipment (UE) that may function as a Relay UE 100, which relays services, or as a UE 350 that receives relayed services.

A Relay UE 100 may include a first communication unit 110 for receiving a Service Catalogue and one or more services from a Remote Service Provider and a second communication unit 120 for communicating with a UE and a processing unit 130 connected to the first and second communication unit and arranged for carry out the steps of the method for relaying services as described in this document.

A UE 350 may include a communication unit 120 for communicating with a Relay UE and a processing unit 130 connected to the communication unit 120 and arranged for carry out the steps of the methods for selecting relayed services as described in this document.

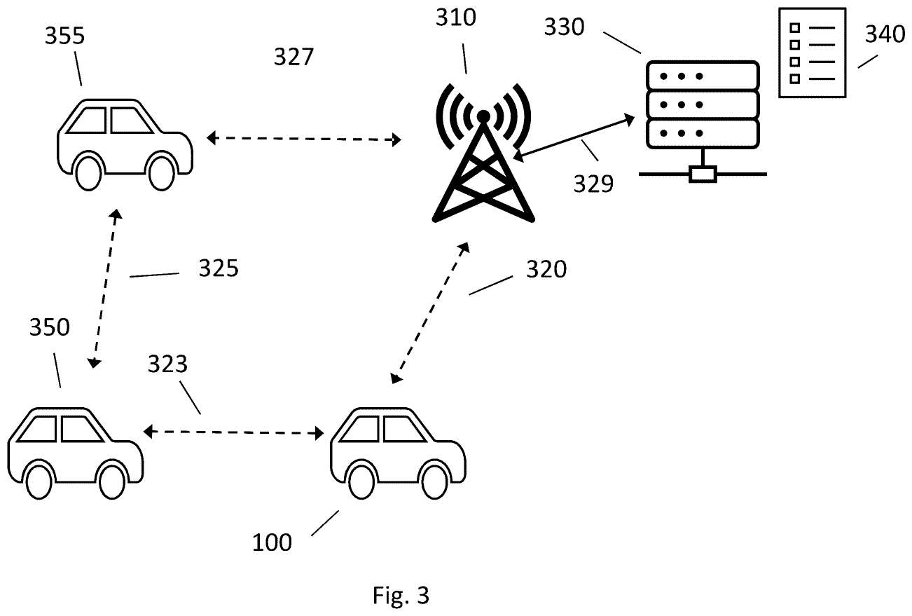

FIG. 3 shows UE 100, 350 and 355 which are vehicles, but each one could be any kind of user equipment, such as a mobile phone, a laptop, or any other computing device, which is arranged for connecting to communication networks. The term “vehicle” may refer to a car, a motorbike, a van, a truck, a bicycle, or a scooter. UE 100 and UE 355 are further arranged for relaying services and are thus referred to as a Relay UEs.

In the example of FIG. 3, Relay UE 100 is connected with a Remote Service Provider 330 using a wireless connection 320 between the Relay UE 100 and a base station 310 and a wired connection 329 between base station 310 and Remote Service Provider 330. In the example of FIG. 3, Relay UE 100 may be located in a cell of the cellular mobile network served by base station 310.

In one or more embodiments, the first communication unit 110 of the Relay UE 100 is a 3GPP Uu interface. In that case, the Remote Service Provider 330 also includes a 3GPP Uu interface to communicate with the Relay UE 100. In one or more other embodiments, the first communication unit 110 of the Relay UE 100 is a 3GPP PC5 interface. In that case, the Remote Service Provider 330 also includes a 3GPP PC5 interface to communicate with the Relay UE 100.

In one or more embodiments, the second communication unit 120 of the Relay UE 100 is a 3GPP PC5 interface. In that case, the UE also includes a 3GPP PC5 interface to communicate with the Relay UE 100.

A Service Catalogue 340 is generated, for example by Remote Service Provider 330, which describes the services that the Remote Service Provider 330 may provide, for example to UE 350. Examples of such services are (i) remote computing, such as for artificial intelligence calculations or machine learning calculations (ii) remote data storage, (iii) infotainment, (iv) entertainment and gaming, and (v) data exchange with other remote entities.

The Service Catalogue 340 may be stored in a cloud system, a V2X server or another UE or any other data storage device that is connected with Relay UE 100. In the example of FIG. 3, the Service Catalogue 340 is stored in the Remote Service Provider 330.

Using the connection to the Remote Service Provider 330, the Relay UE 100 may receive the Service Catalogue 340. According to the present disclosure, the Relay UE generates meta-data, which includes additional information about the services of Service Catalogue for the UE.

From the meta-data it may be derived how the respective service will be experienced by the user of the UE. For the experience of the user, not only the available bandwidth and Quality of Service (e.g., throughput, latency, jitter) of the connection itself is relevant, but also other aspects. The meta-data may thus relate to the (end-to-end) Quality of Service of a respective service; an estimated processing load of the Relay UE, an estimated use of network bandwidth, an estimated network throughput, an estimated network latency and jitter; an estimated energy consumption, a battery status of the Relay UE; costs of a respective service, and/or rating of the Remote Service Provider.

In the example of FIG. 3, the UE 350 is not connected to the cellar mobile network provided by base station 310, for example because UE 350 is too far away from base station 310. However, Relay UE 100 is able to establish a connection 323 between Relay UE 100 and UE 350 using another wireless network technology.

Relay UE 100 may provide information about the Service Catalogue 340 and about the meta-data to UE 350.

Based on the provided information, UE 350 may select one of the services of Remote Service Provider 330, which is then relayed by Relay UE 100 from the Remote Service Provider 330 to UE 350.

In the example of FIG. 3, UE 350 is not only connected to Relay UE 100, but also to Relay UE 355 using a connection 325. Relay UE 355 may also be connected with Remote Service Provider 330 using a wireless connection 327 between the Relay UE 355 and base station 310 and the wired connection 329 between base station 310 and Remote Service Provider 330. Relay UE 355 may be located in another cell of the cellular mobile network served by base station 310.

Relay UE 355 may provide UE 350 information regarding the same Service Catalogue 340, but the information about the meta-data it provides to UE 350 may be different. For example, Relay UE 355 may have more processing power available for relaying services than Relay UE 100. On the basis of the provided information, UE 350 may select a certain service relayed by Relay UE 355 rather than relayed by Relay UE 100.

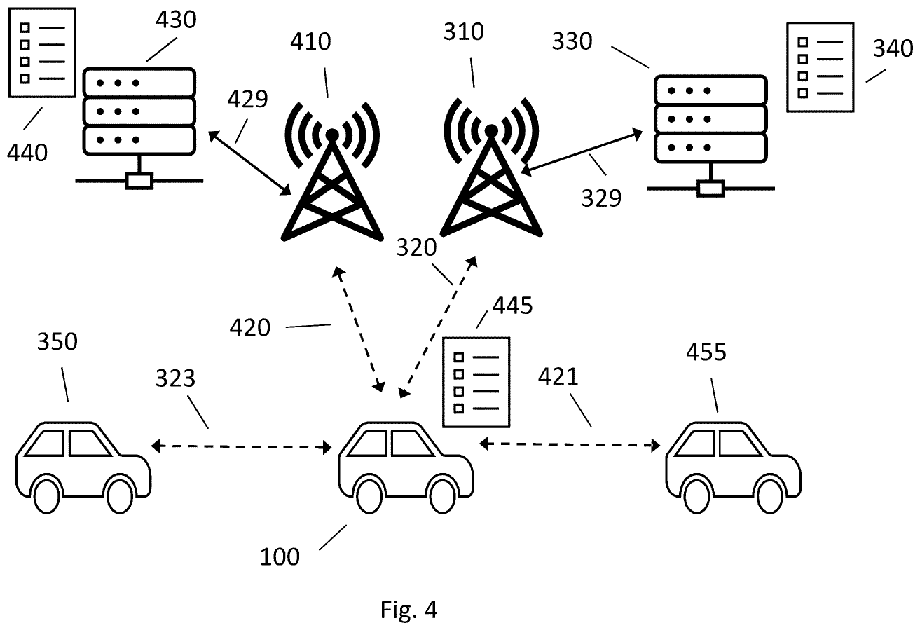

In the example of FIG. 4, it is the case that Relay UE 100 is not only connected to Remote Service Provider 330, but also to another one, Remote Service Provider 430, that may be able to deliver other services.

Relay UE 100 may be connected with Remote Service Provider 430 using a wireless connection 420 between the Relay UE and another base station 410 and a wired connection 429 between base station 410 and Remote Service Provider 430. Relay UE 100 may thus also be located in a cell of the cellular mobile network served by base station 410.

Information about the other services of Remote Service Provider 430 may be included in another Service Catalogue 440. Relay UE 100 may also generate other meta-data, providing additional information about the other services of Remote Service Provider 430. Information about the Service Catalogue and the other meta-data may be provided to UE 350. On the basis of the provided information, UE 350 may select a certain service provided by Remote Service Provider 330 rather than provided by Remote Service Provider 430.

In a further embodiment of the present disclosure, a Relay UE may act as a service broker, wherein the Relay UE is arranged for not only relaying services from one or more Remote Service Providers but also for creating one or more further services based on a selection and/or a combination of services provided by the Remote Service Providers. The Relay UE may also generate a further Service Catalogue for these further services and may generate further meta-data, which includes additional information about the further services that were created.

In the example of FIG. 4, Relay UE 100 may select and/or combine certain service from Remote Service Provider 330 and Remote Service Provider 430 into a set of new or further services. It may then generate a further Service Catalogue 445 for these services, and it may generate meta-data about them and may provide information about the further Service Catalogue 445 and the meta-data to UE 350.

In a further embodiment, Relay UE 100 may be arranged for selecting or combining certain services from the Remote Service Providers 430 and 330 based on the information about their respective Service Catalogues and meta-data and provide the UE 350 only with the information about the further Service Catalogue 445 and the corresponding meta-data to UE 350. It will then provide none or only a selected part of information about Service Catalogue 340 and Service Catalogue 440 to UE 350. Thus, it is the Relay UE 100 that selects the services of Remote Service Providers 430 and 330, which it will offer to UE 350 as relayed services.

In another embodiment, more than one Relay UE may be involved in relaying services to the UE. In the example of FIG. 4, Relay UE 100 may be connected to another Relay UE 455 using a connection 421. Relay UE 455 may be arranged for relaying services from yet another Remote Service Provider (not shown in FIG. 4). Relay UE 455 may then relay services of this Remote Service Provider to Relay UE 100 which in turn relays them to UE 350.

In general, a UE may automatically select (i.e., without a user of the UE making the selection) one of the services based on the provided information. This provided information about services, other services and/or further services, may be logically structured and/or provided with a hierarchy. This will facilitate the automatic selection of services.

FIG. 2 shows a schematic overview of a method 200 for service relaying in a Relay UE of FIG. 1.

Embodiments of the method showed in FIG. 2 may include any combination of the following steps:
210 receiving a Service Catalogue (SC) of a Remote Service Provider;
220 establishing a connection between the Relay UE and a UE, wherein the Remote Service Provider is arranged for providing services to a UE, wherein Service Catalogue includes information about the services, wherein the Relay UE is arranged for relaying one or more of the services from the Remote Service Provider to the UE;
230 generating meta-data, wherein the meta-data includes additional information about the services for the UE;
240 providing information about the Service Catalogue and about the meta-data to the UE; and
250 when the UE selects one of the services based on the provided information, relaying the selected service from the Remote Service Provider to the UE.

In one or more embodiments, the method may further include any combination of the following steps:
215 receiving another Service Catalogue from another Remote Service Provider, wherein the other Remote Service Provider is arranged for providing other services to the UE, wherein the other Service Catalogue includes information about the other services, wherein the Relay UE is arranged for relaying one or more of the other services from the other Remote Service Provider to the UE;
235 generating other meta-data, wherein the other meta-data includes additional information about the other services for the UE;
245 providing information about the other Service Catalogue and about the other meta-data to the UE.

In one or more embodiments the method may further include any combination of the following steps:
207 creating one or more further services based on a combination of services provided by the Remote Service Provider and/or the other services provided by the other Remote Service Provider,
217 generating a further Service Catalogue includes information about the further services;
237 generating further meta-data, wherein the further meta-data includes additional information about the further services for the UE;
247 providing information about the further Service Catalogue and about the further meta-data to the UE.

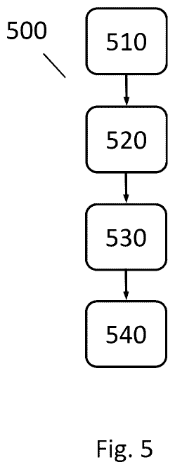

FIG. 5 shows a schematic overview of a method 500 for selecting a relayed service in UE according to one or more embodiment of the present disclosure.

Embodiments of the method showed in FIG. 5 may include any combination of the following steps:
510 establishing a connection between the UE and a Relay UE;
520 receiving information about a Service Catalogue of a Remote Service Provider and about meta-data from a Relay UE, wherein the Service Catalogue includes information about services provided by the Remote Service Provider and wherein the meta-data is generated by the Relay UE and includes additional information about the services;
530 selecting one of the services based on the provided information; and 540 receiving the selected service from the Remote Service Provider relayed by the Relay UE.

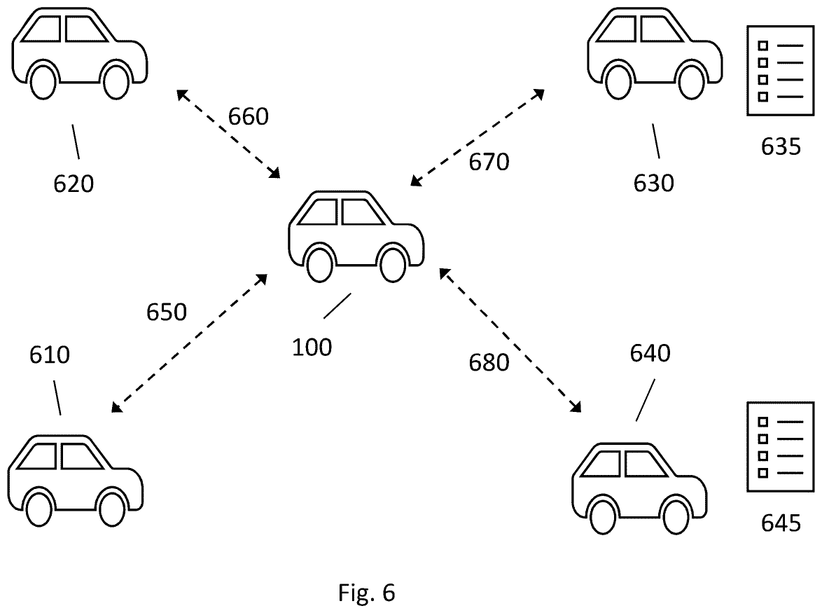

FIG. 6 shows a schematic overview of yet another use case of the present disclosure according to one or more embodiment of the present disclosure. The Relay UE 100 may be connected with a first UE 610 using a first connection 650 and a second UE 620 using a second connection 660. Relay UE 100 may be also connected with a first Remote Service Provider 630 using a third connection 670 and with a second Remote Service Provider 640 using a fourth connection 680.

The first connection 650, the second connection 660, the third connection 670 and/or the fourth connection 680 may be a PC5 connection according to the 3GPP standard.

A first Service Catalogue 635 is associated with the services that first Remote Service Provider 630 can offer, and a second Service Catalogue 645 is associated with the services that second Remote Service Provider 640 can offer. Relay UE may be arranged for forwarding at least a part of the first and/or the second Service Catalogue to the UEs 610, 620. In one or more embodiments, Relay UE 100 may be arranged for building new services based on the services offered by the first and second Remote Service Providers and generating a new Service Catalogue that describes these new services and that is transmitted to the UEs 610, 620.

In general, Relay UE 100 may be arranged for advertising its ability to act as a service broker and may locally connect to one or more UEs 610, 620. In response receiving to the at least part of Service Catalogues, these UEs may request one or more services offered by one or more Remote Service Providers 630, 640 that the Relay UE is connected to.

The UEs 610, 620 may be connected to one or more Relay UEs and may select a certain Relay UE based on the offered service catalogue and additional meta-data (e.g., QoS, load, service costs, estimated service usage, energy consumption, service provider ratings).

In one or more embodiments, the Relay UE 100 may be provided with a Remote Service Provider functionality and thus may be said to be capable of acting as Remote Service Provider. In that case, the Relay UE 100 may be arranged for enabling bidirectional and simultaneous service provisioning across the connected UEs 610, 620 and Remote Service Providers 630, 640.

In the example of FIG. 6, the Relay UE 100 relays services offered by Remote Service Providers 630, 640 directly connected to Relay UE 100. However, in one or more embodiments, services may be relayed using multi-hop communications. In that case, the Rely UE 100 may relay services offered by Remote Service Providers that are relayed to Relay UE 100 using one or more other Relay UEs.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

The benefits and advantages that may be provided by the present disclosure have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that includes a set of elements is not limited to only those elements and may include other elements not expressly listed or inherent to the claimed embodiment.

While the present disclosure has been described with reference to particular embodiments, it should be understood that the embodiments are illustrative and that the scope of the present disclosure is not limited to these embodiments. Many variations, modifications, additions and improvements to the embodiments described above are possible. It is contemplated that these variations, modifications, additions and improvements fall within the scope of the present disclosure as detailed within the following claims.

1. Method for service relaying in a Relay User Equipment (UE), comprising:
receiving a Service Catalogue (SC) of a remote service provider,
establishing a connection between the Relay UE and a UE, wherein the remote service provider is arranged for providing services to a UE; wherein the SC comprises information about the services; wherein the Relay UE is arranged for relaying one or more of the services from the remote service provider to the UE;
generating meta-data, wherein the meta-data comprises additional information about the services for the UE;
providing information about the SC and about the meta-data to the UE; and,
when the UE selects one of the services based on the provided information, relaying the selected service from the remote service provider to the UE.

2. The method according to claim 1, wherein the meta-data comprises additional information regarding at least one of a group comprising:
quality of service of a respective service;
estimated processing load of the Relay UE;
estimated use of network resources;
estimated energy consumption;
battery status of the Relay UE;
costs of a respective service; and,
rating of the remote service provider.

3. The method according to claim 1, wherein the services comprise at least one of services at a connection layer or services at an application layer, wherein the services at an application-layer comprise at least one of a group comprising:
remote computing for artificial intelligence calculations or machine learning calculations;
remote storage of data;
infotainment;
entertainment and gaming;
data exchange with remote entities.

4. The method according to claim 1, wherein said SC is received from at least one of a group comprising:
a cloud system;
a V2X server;
a Remote Service Provider; and,
another UE.

5. The method according to claim 1, wherein the Relay UE and remote service provider are provided in a single device.

6. The method according to claim 1, further comprising the steps of:
receiving another SC from another remote service provider, wherein the other remote service provider is arranged for providing other services to the UE; wherein the other SC comprises information about the other services, and wherein the Relay UE is arranged for relaying one or more of the other services from the other remote service provider to the UE;
generating other meta-data, wherein the other meta-data comprises additional information about the other services for the UE; and
providing information about the other SC and about the other meta-data to the UE.

7. The method according to the preceding claim 6, further comprising:
creating one or more further services based on at least one of a selection or combination of services provided by at least one of the remote service provider or the other services provided by the other remote service provider;
generating a further SC comprising information about the further services;
generating further meta-data, wherein the further meta-data comprises additional information about the further services for the UE; and
providing information about the further SC and about the further meta-data to the UE.

8. The method according to claim 1, further comprising generating the information about at least one of services, other services, or further services, in which the information is at least one of logically structured or provided with a hierarchy.

9. The method for selecting a relayed service in user equipment (UE), comprising:
establishing a connection between the UE and a Relay UE;
receiving information about a service catalogue of a remote service provider and about meta-data from a Relay UE, wherein the service catalogue comprises information about services provided by the remote service provider and wherein the meta-data is generated by the Relay UE and comprises additional information about the services;
selecting one of the services based on the provided information; and;
receiving the selected service from the remote service provider relayed by the Relay UE.

10. A relay UE for Service relaying, comprising:
a first communication unit for communication with a remote service provider and a second communication unit for communicating with a UE; and
a processing unit connected to the first communication unit and the second communication unit, and arranged for carry out the method of claim 1.

11. A UE for receiving a relayed service, comprising:
a communication unit for communicating with a Relay UE; and
a processing unit connected to the communication unit and arranged for carry out the method of claim 9.

12. A computer program comprising instructions which, when the program is executed by a computer, cause the computer to carry out the method of claim 1.

13. A computer-readable medium having stored thereon the computer program of claim 12.
